(19) United States
(12) Patent Application Publication
(10) Pub. No.: US 2009/0059500 A1
(43) Pub. Date: Mar. 5, 2009

(54) Plasma Display System

(75) Inventors: Mayumi Fukuyama, Tsukuba (JP); Akito Tanokuchi, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/189,898

(22) Filed: Aug. 12, 2008

(30) Foreign Application Priority Data
Aug. 30, 2007 (JP) 2007-224674

(51) Int. Cl. G06F 1/16

(52) U.S. Cl. 361/681

(57) ABSTRACT

A plasma display system capable of enhancing stiffness against deformation. The system comprising a plasma display panel (PDP) 1; a sheet-like chassis 2 bonded to a back surface of the PDP 1; a circuit board 3 outputting an electric signal to the PDP 1; a casing 4 accommodating therein the PDP 1, the chassis 2, and the circuit board 3; a reinforcement member 5 disposed as an adjunct at a back surface of the chassis 2, the reinforcement member 5 extending in a plane direction of the chassis 2 to stick outwardly therefrom; and a fixing means (e.g. through holes 7a to 7d) disposed in each of overhangs 6a to 6d of the reinforcement member 5 sticking out in a plurality of directions from the chassis 2, the fixing means fixing the casing 4 in place.

### BACKGROUND OF THE INVENTION

1. Field of the Invention

The present invention relates to a plasma display system for displaying images with a plasma display panel.

2. Description of Related Art

A plasma display system typically includes a plasma display panel (hereinafter abbreviated to “PDP”), a sheet-like chassis bonded to a back surface of the PDP, a circuit board outputting an electric signal to the PDP, and a casing accommodating therein the PDP, the chassis, and the circuit board (see, for example, JP-A-2000-200046).

A plasma display system disclosed in JP-A-2000-200046 includes a ladder-like frame disposed as an adjunct at a back surface of a chassis. The back surface of the chassis also includes a first boss and a second boss disposed on an inner side thereof. The first boss has a threaded hole formed therein for mounting a circuit board. The second boss has a threaded hole formed therein for mounting a back cover. The circuit board is secured in place by being screwed onto the first boss. The back cover is secured in place by being screwed onto the second boss, while being supported by brackets attached to an upper left corner and an upper right corner of the chassis. A cabinet (front cover) is locked onto the brackets at the upper left corner and the upper right corner of the chassis. Further, the cabinet is secured in place by being screwed from a downward direction to brackets attached at a lower left corner and a lower right corner of the chassis.

### SUMMARY OF THE INVENTION

There is a need in the plasma display system for reduction in weight from viewpoints, for example, of wall-hanging applications and reduction in manufacturing cost. Use of a thinner sheet for the chassis is one possible way to achieve the foregoing purposes. A thinner chassis, however, results in a reduced stiffness. Strength of the chassis is then likely to be reduced against deformation that could occur when vibration or the like acts thereon during transportation. In the plasma display system disclosed in JP-A-2000-200046, there is still room for further improvement in terms of stiffness against deformation, though the frame disposed at the back surface of the chassis enhances the stiffness against deformation.

It is an object of the present invention to provide a plasma display system capable of enhancing stiffness against deformation.

To achieve the foregoing object, a first aspect of the present invention provides a plasma display system comprising: a plasma display panel; a sheet-like chassis bonded to a back surface of the plasma display panel; a circuit board outputting an electric signal to the plasma display panel; a casing accommodating therein the plasma display panel, the chassis, and the circuit board; a reinforcement member disposed as an adjunct at a back surface of the chassis, the reinforcement member extending in a plane direction of the chassis to stick outwardly therefrom; and a fixing means disposed in each of overhangs of the reinforcement member sticking out in a plurality of directions from the chassis, the fixing means fixing the casing in place.

In accordance with the first aspect of the present invention, each of the overhangs of the reinforcement member sticking out in a plurality of directions from the chassis includes the fixing means fixing the casing in place. As compared, for example, with an arrangement in which a fixing means is disposed in an inner portion on the back surface of the chassis, a range of positions of the chassis to be fixed with the casing by way of the fixing means can be expanded, thus enhancing strength of the chassis relative to end portion deformation (local deformation). In addition, when vibration due to transportation, or the like, acts, a local inertia force of the casing is applied to the fixing means. Intervention of the reinforcement member, however, helps reduce a force being applied to the chassis, thus enhancing stiffness against deformation.

According to the aspect of the present invention, the stiffness against deformation can be enhanced.

### BRIEF DESCRIPTION OF THE DRAWINGS

FIG. 1 is a perspective view showing a structure of a plasma display system according to an embodiment of the present invention.

FIG. 2 is a perspective view showing a structure of a plasma display system according to a modified example of the present invention.

FIG. 3 is a partly enlarged perspective view showing a structure of a plasma display system according to another modified example of the present invention.

FIG. 4 is a perspective view showing a structure of a plasma display system according to still another modified example of the present invention.

### DETAILED DESCRIPTION OF THE PREFERRED EMBODIMENTS

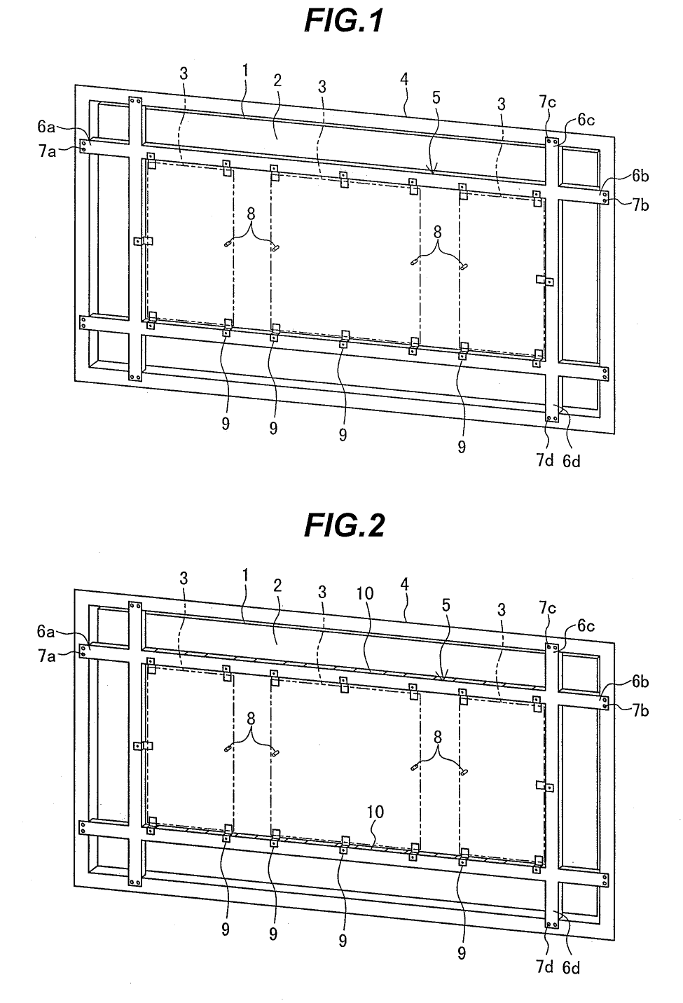

An embodiment of the present invention will be described below with reference to the drawings. FIG. 1 is a perspective view showing the structure of the plasma display system according to the embodiment of the present invention.

Referring to FIG. 1, the plasma display system includes a plasma display panel (hereinafter abbreviated to “PDP”) 1, a sheet-like chassis 2 bonded to a back surface of the PDP 1 with an adhesive or the like, a circuit board 3 outputting an electric signal to the PDP 1, and a casing 4 accommodating therein the PDP 1, the chassis 2, and the circuit board 3.

A reinforcement member 5 having, for example, a C-shaped cross section is disposed on a back surface of the chassis 2 so as to form a lattice. In accordance with this embodiment of the present invention, the reinforcement member 5 includes two each sub-members extending in a longitudinal, or a long edge, direction (horizontal direction in FIG. 1) and a short edge direction (vertical direction in FIG. 1), respectively, of the chassis 2. The reinforcement member 5 further includes two each overhangs disposed relative to each of four edges of the chassis 2. Specifically, two overhangs 6a stick out from a left edge side (left side in FIG. 1) of the chassis 2; two overhangs 6b stick out from a right edge side (right side in FIG. 1) of the chassis 2; two overhangs 6c stick out from an upper edge side (upper side in FIG. 1) of the chassis 2; and two overhangs 6d stick out from a lower edge side (lower side in FIG. 1) of the chassis 2. Each of these overhangs 6a to 6d is disposed near each of the four corners of the chassis 2.

The overhang 6a of the reinforcement member 5 has a leading end formed so as not to interfere with the casing 4, typically including two through holes 7a formed therein. Similarly, each of the overhangs 6b to 6d of the reinforcement member 5 has a leading end formed so as not to interfere with the casing 4, typically including through holes 7b to 7d formed therein, respectively. A leading end of each of screws (not shown) passed through the through holes 7a to 7d, respectively, of the reinforcement member 5 is then threaded into each of threaded holes (not shown) of the casing 4, so that the casing 4 is fixed to the reinforcement member 5.

The back surface of the chassis 2 includes a boss 8 for supporting the circuit board 3 inside the lattice of the reinforcement member 5. The boss 8 includes threaded holes (not shown) formed therein for fixing the circuit board 3. The reinforcement member 5 has a plurality of threaded holes (not shown) formed in an upper portion thereof. Shouldered brackets (circuit board support member) 9 are fixed in place with screws threaded into the threaded holes of the reinforcement member 5. Though not shown in greater detail, the shouldered bracket 9 has a fixing support portion formed so as not to contact the chassis 2 and so as to approach the chassis 2 from the upper portion of the reinforcement member 5. The fixing support portion includes a threaded hole formed therein for fixing the circuit board 3. The circuit board 3 includes through holes (not shown) at positions corresponding to the boss 8 and the shouldered brackets 9. Screws which have been passed through the through holes of the circuit board 3 are threaded into the threaded holes of the boss 8 and in the shouldered brackets 9, so that the circuit board 3 is fixed in place.

In the plasma display system according to this embodiment of the present invention having arrangements as described above, as a fixing means for fixing the casing 4, the casing 4 is screwed in place using the through holes 7a to 7d formed in the overhangs 6a to 6d of the reinforcement member 5 and the threaded holes formed in the casing 4. As compared, for example, with an arrangement in which a fixing means is disposed in an inner portion on the back surface of the chassis 2, a range of positions of the chassis 2 to be fixed with the casing 4 by way of the fixing means can be expanded, thus enhancing strength of the chassis 2 relative to end portion deformation (local deformation). In addition, when vibration due to transportation, or the like, acts, a local inertia force of the casing 4 is applied to the fixing means. Intervention of the reinforcement member 5, however, helps reduce a force being applied to the chassis 2, thus enhancing stiffness against deformation.

In the plasma display system according to this embodiment of the present invention, the circuit board 3 is fixedly supported by, not only the boss 8 disposed on the back surface of the chassis 2, but also the shouldered brackets 9 attached to the reinforcement member 5. This arrangement achieves the following effect. Specifically, though an inertia force is applied to the circuit board 3 when vibration due to transportation, or the like, acts, the intervention of the reinforcement member 5 helps reduce the force being applied to the chassis 2, thus enhancing the stiffness against deformation. Further, the shouldered brackets 9 have the fixing support portion, which is formed so as to approach the chassis 2 from the upper portion of the reinforcement member 5, for fixedly supporting the circuit board 3. This helps suppress the circuit board 3 from protruding rearwardly of the system as much as possible, thus preventing the entire system from becoming large.

In the plasma display system according to this embodiment of the present invention, the stiffness against deformation can be enhanced as described above. As a result, the chassis 2 can be made even thinner for a reduced weight.

In the plasma display system according to the above embodiment of the present invention, the arrangement is exemplified in which, as the fixing means for fixing the casing 4, the casing 4 is screwed in place using the through holes 7a to 7d formed in the overhangs 6a to 6d of the reinforcement member 5 and the threaded holes formed in the casing 4. This is not the only possible arrangement. Specifically, the casing 4 may be screwed in place using, for example, threaded holes formed in the overhangs 6a to 6d of the reinforcement member 5 and through holes formed in the casing 4. It is further possible, for example, that through holes are formed in both the overhangs 6a to 6d of the reinforcement member 5 and the casing 4 and that the reinforcement member 5 and the casing 4 are clamped together using screws and nuts. In such an arrangement, too, the same effect as noted above can be achieved.

In the plasma display system according to the above embodiment of the present invention, the arrangement is exemplified in which, the circuit board 3 is fixedly supported by the boss 8 disposed on the chassis 2 and the shouldered brackets 9 attached to the reinforcement member 5. This is not the only possible arrangement. Specifically, for example, the circuit board 3 may be fixedly supported by only the shouldered brackets 9. In such an arrangement, too, the same effect as noted above can be achieved.

In the plasma display system according to the above embodiment of the present invention, the arrangement is exemplified in which, the shouldered brackets 9 are screwed to the reinforcement member 5. This is not the only possible arrangement and the shouldered brackets 9 may be bonded together through, for example, a welding means or the like. Further, in the plasma display system according to the above embodiment of the present invention, the arrangement is exemplified in which, the reinforcement member 5 and the chassis 2 are separately formed from each other and are then bonded together through welding, riveting, or the like. This is not the only possible arrangement and the reinforcement member 5 and the chassis 2 may be formed integrally with each other. In such an arrangement, too, the same effect as noted above can be achieved.

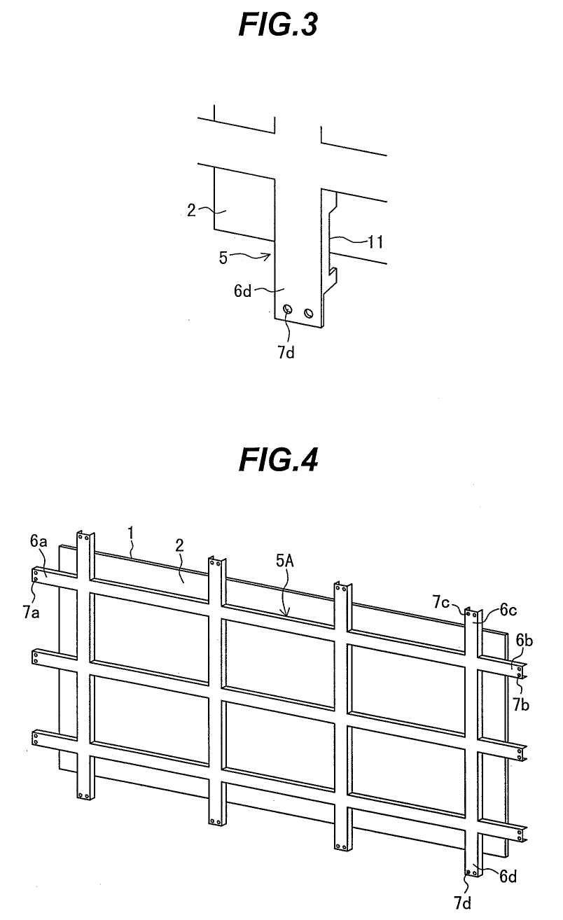

Though not specifically described for the plasma display system according to the above embodiment of the present invention, the reinforcement member 5 may have both sides thereof including air vent holes 10 formed therein corresponding to disposition of the circuit board 3 as shown in FIG. 2. This arrangement helps enhance cooling effect of the circuit board 3 and contribute to reduction in weight. Referring to FIG. 3, the reinforcement member 5 may have a cable insertion hole 11 for passing a cable (not shown) therethrough. The cable insertion hole 11 may be formed in a side surface of the reinforcement member 5 disposed near an outer edge of the chassis 2. This makes handling for the cable easy and contributes to weight reduction.

In the plasma display system according to the above embodiment of the present invention, the arrangement is exemplified in which, the reinforcement member 5 having a C-shaped cross section is disposed on a back surface of the chassis 2 so as to form a lattice. More specifically, the reinforcement member 5 includes two each sub-members extending in the long edge direction and the short edge direction, respectively, of the chassis 2. Further, the overhangs 6a to 6d stick out from the left edge side, the right edge side, the upper edge side, and the lower edge side, respectively, of the chassis 2. This is not the only possible arrangement. Specifically, for example, the reinforcement member having an L-shaped or circular cross section or the like may be disposed. Alternatively, the reinforcement member may have a different configuration without departing from the spirit and scope of the present invention. Specifically, the reinforcement member may have three each sub-members extending in the long edge and short edge directions, respectively. A specific example of such an arrangement is depicted in FIG. 4 (for convenience sake, however, the circuit board, the casing, and the like are not shown in FIG. 4). Referring to FIG. 4, a reinforcement member 5A includes three sub-members disposed in the long edge direction and four sub-members disposed in the short edge direction. The reinforcement member 5A may include three overhangs 6a sticking out from the left edge side of the chassis 2; three overhangs 6b sticking out from the right edge side of the chassis 2; four overhangs 6c sticking out from the upper edge side of the chassis 2; and four overhangs 6d sticking out from the lower edge side of the chassis 2. Alternatively, the reinforcement member may, for example, be disposed in the long edge direction only, with overhangs sticking out from the left edge and right edge sides of the chassis 2. The reinforcement member may, for example, even be disposed in the short edge direction only, with overhangs sticking out from the upper edge and lower edge sides of the chassis 2. The reinforcement member may even be disposed in an obliquely extending direction. In each of these modified examples, too, the same effect as noted with reference to the first embodiment of the present invention can be achieved.

What is claimed is:

1. A plasma display system comprising:
a plasma display panel;
a sheet-like chassis bonded to a back surface of said plasma display panel;
a circuit board outputting an electric signal to said plasma display panel;
a casing accommodating therein said plasma display panel, said chassis, and said circuit board;
a reinforcement member disposed as an adjunct at a back surface of said chassis, said reinforcement member extending in a plane direction of said chassis to stick outwardly therefrom; and
a fixing means disposed in each of overhangs of said reinforcement member sticking out in a plurality of directions from said chassis, said fixing means fixing said casing in place.

2. The plasma display system according to claim 1, wherein said fixing means includes:
a through hole formed in one of said reinforcement member overhang and said casing,
a threaded hole formed in the other of said reinforcement member overhang and said casing, and
a screw passed through said through hole and threaded into said threaded hole.

3. The plasma display system according to claim 1, further comprising:
a circuit board support member disposed at said reinforcement member and including a fixing support portion formed so as not to contact said chassis and so as to approach said chassis from an upper portion of said reinforcement member, the circuit board support member fixedly supporting said circuit board with the fixing support portion.
